(19) United States
(12) Patent Application Publication
(10) Pub. No.: US 2020/0226531 A1
(43) Pub. Date: Jul. 16, 2020

(54) PERSON-IN-CHARGE ALLOCATION APPARATUS AND METHOD

(71) Applicant: Hitachi, Ltd., Tokyo (JP)

(72) Inventors: Naoaki YAMAGUCHI, Tokyo (JP); Kazuki OOTSUBO, Tokyo (JP)

(21) Appl. No.: 16/554,715

(22) Filed: Aug. 29, 2019

(30) Foreign Application Priority Data
Jan. 11, 2019 (JP) 2019-003086

(51) Int. Cl. G06Q 10/06; G06Q 50/20

(52) U.S. Cl. CPC G06Q 10/063112; G06Q 50/20

(57) ABSTRACT

An operation team management DB 31 stores management information indicating a possessed skill which is a skill possessed by a person in charge and an educational skill which is a skill to be mastered by the person in charge for each person in charge. The person-in-charge determining unit 32 allocates an educator and a person to be educated while setting a person in charge who possesses a required skill as the possessed skill as the educator and setting a person in charge who should master the required skill as the educational skill as the person to be educated on the basis of event information indicating the required skill which is a skill for coping with an event and the management information.

### CROSS-REFERENCE TO RELATED APPLICATION

The present application claims priority from Japanese application JP 2019-003086, filed on Jan. 11, 2019, the contents of which is hereby incorporated by reference into this application.

### BACKGROUND

The present invention relates to a person-in-charge allocation apparatus and method for allocating a person in charge who is to cope with an event occurring in an information system.

In operation of an information system, it is important to handle an event such as a failure. At this time, there is a case where a plurality of persons in charge within an operation team handle the event in cooperation with each other.

Japanese Patent No. 5291604, Japanese Patent No. 5420385 and Japanese Patent No. 4865511 disclose techniques for efficiently performing operation for coping with an event which has occurred. Japanese Patent No. 5291604 discloses a technique of determining a person in charge who handles an event on the basis of a skill, busyness and past handling history of a person in charge. Japanese Patent No. 5420385 discloses a technique for suppressing delay in handling of an event. Japanese Patent No. 4865511 discloses a method for determining priority for coping with events. By using these methods, it is possible to improve efficiency of coping of individual events.

### SUMMARY

A person in charge who handles an event which has occurred in an information system needs to have a predetermined skill to cope with the event. Such a skill tends to belong to a specific person in charge within an operation team, and may not be shared with other persons in charge such as a new person in charge.

In the techniques disclosed in Japanese Patent No. 5291604, Japanese Patent No. 5420385 and Japanese Patent No. 4865511, developing a person in charge and sharing of a skill are not taken into account. Therefore, if members of the operation team are changed, because there is a possibility that a skill is lost from the operation team, it is difficult to stably operate the information system.

It is an object of the present invention to provide a person-in-charge allocation apparatus and method which can stably operate an information system.

A person-in-charge allocation apparatus according to one aspect of the present invention is a person-in-charge allocation apparatus which allocates a handler who is to cope with an event from a plurality of persons in charge, the person-in-charge allocation apparatus including a storage unit configured to store management information indicating a possessed skill which is a skill possessed by the person in charge and an educational skill which is a skill to be mastered by the person in charge for each of the persons in charge, and a person-in-charge determining unit configured to set a person in charge who possesses the required skill as the possessed skill as an educator and to set a person in charge who is to master the required skill as the educational skill as the person to be educated based on event information indicating a required skill which is a skill for coping with the event and the management information, and then to allocate the educator and the person to be educated as the handlers.

Further, a method according to one aspect of the present invention is a method for allocating a handler who is to cope with an event from a plurality of persons in charge, the method including storing management information indicating a possessed skill which is a skill possessed by the person in charge and an educational skill which is a skill to be mastered by the person in charge, for each of the persons in charge; and setting a person in charge who possesses the required skill as the possessed skill as an educator and setting a person in charge who is to master the required skill as the educational skill as the person to be educated based on event information indicating a required skill which is a skill for coping with the event and the management information, and then allocating the educator and the person to be educated as the handlers.

According to the present invention, it is possible to stably operate an information system.

### BRIEF DESCRIPTION OF THE DRAWINGS

FIG. 1 is a diagram illustrating an information system according to an embodiment of the present invention;

FIG. 2 is a diagram illustrating an example of an event table;

FIG. 3 is a diagram illustrating an example of a person-in-charge table;

FIG. 4 is a diagram illustrating an example of a possessed skill table;

FIG. 5 is a diagram illustrating an example of an educational skill table;

FIG. 6 is a diagram illustrating an example of an operation team state table;

FIG. 7 is a flowchart for explaining operation of a person-in-charge determining unit;

FIG. 8 is a flowchart for explaining a processing of acquiring a list of persons in charge who can handle an event, in more detail;

FIG. 9 is a flowchart for explaining a processing of classifying persons in charge in more detail;

FIG. 10 is a flowchart for explaining a processing of examining policy for determining a person in charge in more detail;

FIG. 11 is a flowchart for explaining a processing of determining a handler in more detail;

FIG. 12 is a flowchart for explaining a processing of determining a person in charge so that a risk becomes a minimum, in more detail;

FIG. 13 is a flowchart for explaining a processing of determining a person in charge so that emphasis is placed on education, in more detail;

FIG. 14 is a flowchart for explaining a processing of determining a person in charge so that emphasis is placed on cost, in more detail;

FIG. 15 is a flowchart for explaining operation of an information updating unit 33;

FIG. 16 is a flowchart for explaining skill feedback a processing in more detail; and

FIG. 17 is a flowchart for explaining an operation team feedback processing in more detail.

### DETAILED DESCRIPTION OF THE EMBODIMENT

An embodiment of the present invention will be described below with reference to the drawings. The same reference numerals will be assigned to components having the same functions in the respective drawings, and description thereof will be omitted.

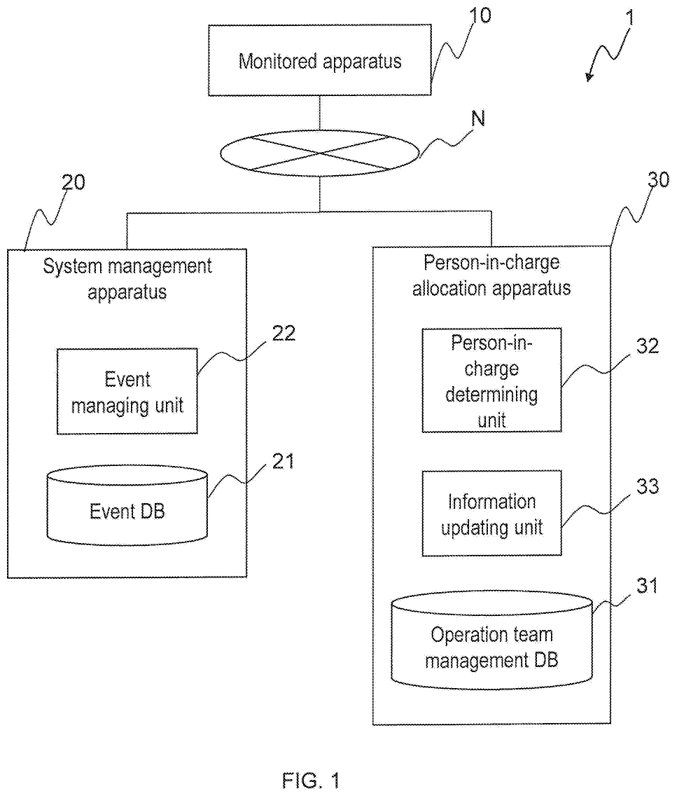

FIG. 1 is a diagram illustrating an information system of an embodiment of the present invention. As illustrated in FIG. 1, an information system 1 includes a monitored apparatus 10, a system management apparatus 20, and a person-in-charge allocation apparatus 30. The monitored apparatus 10, the system management apparatus 20 and the person-in-charge allocation apparatus 30 are coupled to each other, for example, via a network N.

The monitored apparatus 10 is an information processing apparatus which is monitored by the system management apparatus 20 as to whether or not an event such as a failure has occurred. There may be a plurality of monitored apparatuses 10.

The system management apparatus 20 is a monitoring apparatus which monitors as to whether or not an event has occurred at the monitored apparatus 10. The system management apparatus 20 includes an event DB 21 and an event managing unit 22.

The event DB 21 stores an event table which is event information regarding events which have occurred at the monitored apparatus 10.

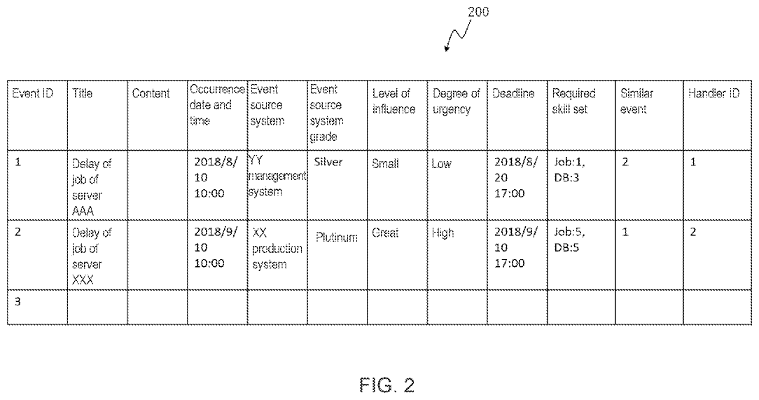

FIG. 2 is a diagram illustrating an example of the event table. In FIG. 2, the event table 200 indicates a title of the event, content of the event, date and time at which the event has occurred, an event source system which indicates the monitored apparatus 10 at which the event has occurred, an event source system grade indicating a grade of the monitored apparatus 10, a level of influence of the event on the monitored apparatus 10, a degree of urgency of the event, a deadline for coping with the event, a required skill set indicating required skills which are skills required for coping with the event, an event ID of a similar event indicating a similar event, and a handler ID which is a person-in-charge ID of a handler who is a person in charge who is to cope with the event for each event ID for identifying the event. The required skill set indicates a required skill level which is a level desired for coping with the event for each of the required skills (such as Job and DB).

In the present embodiment, only information regarding an ongoing event (event which has not been coped with) is included in the event table. However, it is also possible to include information regarding events which have been coped with in the event table by, for example, adding information indicating whether or not coping has been finished for the events.

The event managing unit 22 monitors whether or not an event has occurred at the monitored apparatus 10. In a case where an event has occurred, the event managing unit 22 generates a record regarding the event which has occurred and adds the record to an event table within the event DB 21. Because a handler is not yet determined at this time point, a handler ID in the generated record is blank.

Further, the event managing unit 22 transmits the event table to which the record is added to the person-in-charge allocation apparatus 30 to determine a handler of the event which has occurred at the monitored apparatus 10. At this time, the event managing unit 22 may transmit only information required for determining a handler in the event table. The information required for determining a handler includes, for example, an event ID, a degree of urgency, a required skill set, handler IDs (of other ongoing events), or the like.

The person-in-charge allocation apparatus 30 determines a handler who is to cope with the event which has occurred at the monitored apparatus 10 within an operation team including a plurality of persons in charge. The person-in-charge allocation apparatus 30 includes an operation team management DB 31, a person-in-charge determining unit 32 and an information updating unit 33.

The operation team management DB 31 is a storage unit which stores management information for managing the operation team. The management information includes a person-in-charge table regarding persons in charge, a possessed skill table regarding possessed skills which are possessed by the persons in charge, an educational skill table regarding educational skills which are skills to be mastered by the persons in charge, and an operation team state table regarding a state of the operation team.

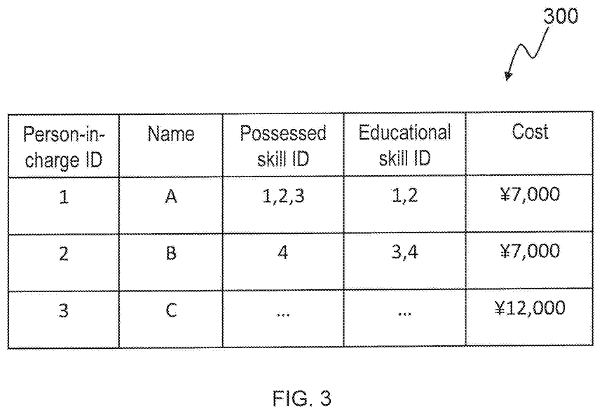

FIG. 3 is a diagram illustrating an example of the person-in-charge table. The person-in-charge table 300 illustrated in FIG. 3 indicates person-in-charge IDs, name of the persons in charge, possessed skill IDs which are skill IDs for identifying possessed skills of the persons in charge, educational skill IDs which are skill IDs for identifying educational skills of the persons in charge and cost (expense) required for persons in charge to cope with an event. There may be a plurality of possessed skill IDs and educational skill IDs for one person-in-charge ID. Although the cost is expense per day in the example of FIG. 3, the cost may be expense per hour, expense per event, or the like.

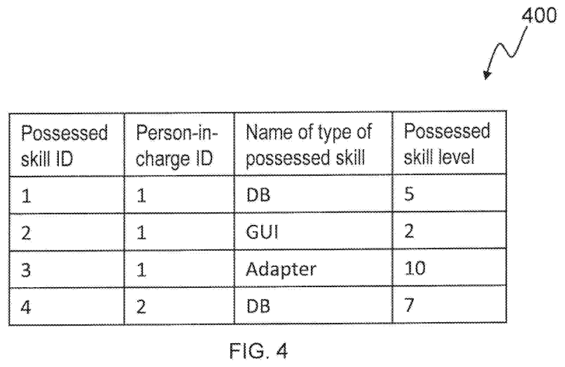

FIG. 4 is a diagram illustrating an example of the possessed skill table. The possessed skill table 400 illustrated in FIG. 4 indicates possessed skill IDs, person-in-charge IDs of persons in charge having the possessed skills, types of possessed skills, possessed skill levels which are levels of the persons in charge concerning the possessed skills.

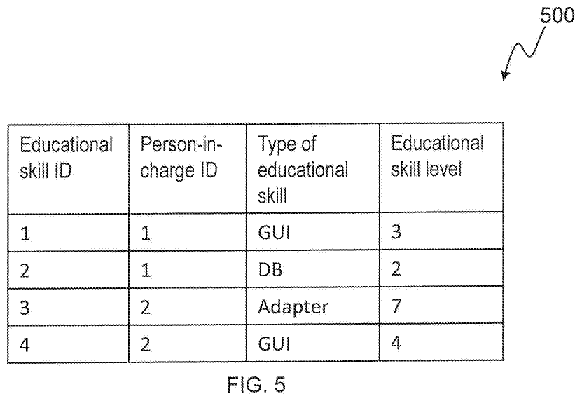

FIG. 5 is a diagram illustrating an example of the educational skill table. The educational skill table 500 illustrated in FIG. 5 indicates educational skill IDs, person-in-charge IDs of persons in charge who are to master educational skills, types of educational skills, and educational skill levels which are levels of the educational skills, to be mastered by the persons in charge.

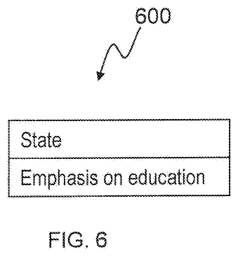

FIG. 6 is a diagram illustrating an example of the operation team state table. The operation team state table 600 illustrated in FIG. 6 indicates a state of the operation team. In the present embodiment, the state of the operation team includes a state where emphasis is placed on education in which emphasis is placed on education (sharing of skills), and a state where emphasis is placed on cost in which emphasis is placed on lower cost instead of emphasis being placed on education.

The person-in-charge determining unit 32 stores the event table from the system management apparatus 20 in the operation team management DB 31. The person-in-charge determining unit 32 determines a handler who is to cope with the event which has occurred at the monitored apparatus 10 on the basis of the event table and the management information stored in the operation team management DB 31. Note that the person-in-charge determining unit 32 may store the event table from the system management apparatus 20 in a memory (not illustrated) provided at the system management apparatus 20 or may read the event table from the system management apparatus 20 when necessary.

The information updating unit 33 updates the management information on the basis of a result of allocation of the handler by the person-in-charge determining unit 32 and the management information stored in the operation team management DB 31.

Note that a configuration illustrated in FIG. 1 is merely an example, and the configuration is not limited to the present configuration. For example, the person-in-charge allocation apparatus 30 may include part or all of the functions of the system management apparatus 20.

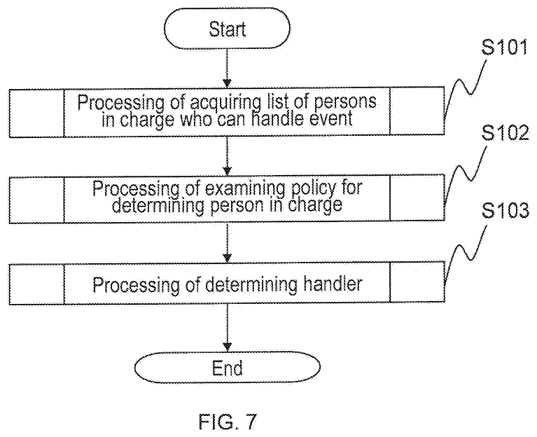

FIG. 7 is a flowchart for explaining operation of the person-in-charge determining unit 32.

The person-in-charge determining unit 32 first executes a processing of acquiring a list of persons in charge who can handle an event, which acquires a list of candidates for a person in charge who become candidates for a handler as a list of candidates for a person in charge on the basis of the event table and the management information stored in the operation team management DB 31 (step S101).

Subsequently, the person-in-charge determining unit 32 executes a processing of examining policy for determining a person in charge, which selects policy for determining a person in charge for determining a handler among the candidates for the person in charge included in the list of candidates for the person in charge acquired in step S101 (step S102).

The person-in-charge determining unit 32 then executes a processing of determining a handler, which determines a handler from the candidates for the person in charge included in the list of candidates for the person in charge in accordance with the policy for determining a person in charge selected in step S102 (step S103), and finishes the processing.

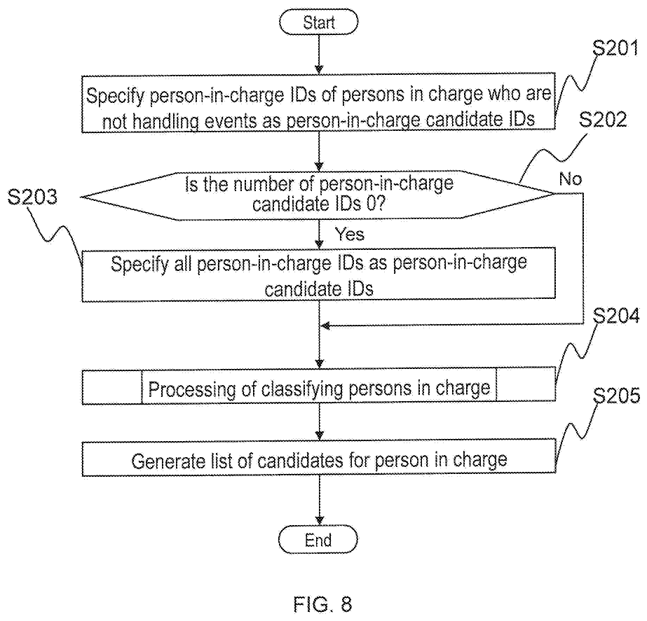

FIG. 8 is a flowchart for explaining the processing of acquiring a list of persons in charge who can handle an event in step S101 in FIG. 7 in more detail.

In the processing of acquiring a list of persons in charge who can handle an event, first, the person-in-charge determining unit 32 sets persons in charge who are not handling events as the candidates for the person in charge and specifies person-in-charge IDs of the candidates for the person in charge as person-in-charge candidate IDs on the basis of the event table and the management information stored in the operation team management DB 31 (step S201). For example, the person-in-charge determining unit 32 specifies IDs obtained by excluding the handler IDs included in the event table from the person-in-charge IDs included in the person-in-charge table within the management information, as the person-in-charge candidate IDs.

The person-in-charge determining unit 32 judges whether or not the number of person-in-charge candidate IDs is 0, that is, whether or not there is no candidate for a person in charge (step S202).

In a case where the number of person-in-charge candidate IDs is 0, the person-in-charge determining unit 32 specifies all the person-in-charge IDs included in the person-in-charge table as the person-in-charge candidate IDs (step S203).

In a case where the number of person-in-charge candidate IDs is 1 or more in step S202 or in a case where step S203 is finished, the person-in-charge determining unit 32 performs a processing of classifying persons in charge, which classifies the candidates for the person in charge into a plurality of classes, and generates a list of person-in-charge candidate IDs for each class (step S204).

The person-in-charge determining unit 32 then generates the list of person-in-charge candidate IDs for each class as a list of candidates for the person in charge (step S205).

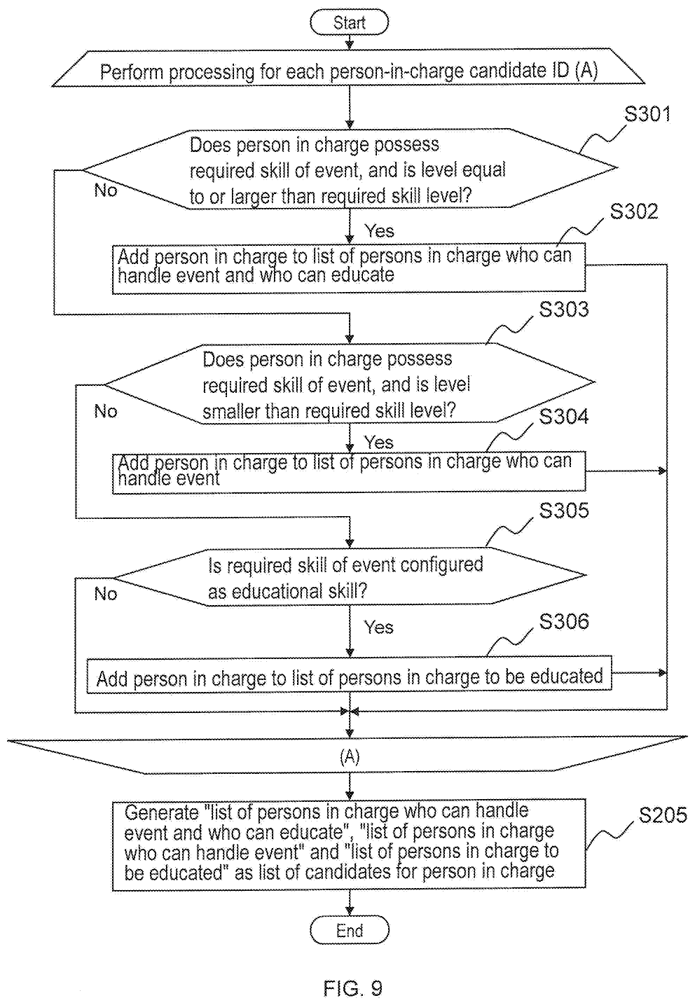

FIG. 9 is a flowchart for explaining the processing of classifying persons in charge in step S204 in FIG. 8 in more detail.

In the processing of classifying persons in charge, the person-in-charge determining unit 32 repeats processing from step S301 to S306 for each of the person-in-charge candidate IDs (loop A).

In the loop A, the person-in-charge determining unit 32 specifies possessed skills possessed by the candidates for the person in charge having the person-in-charge candidate IDs and possessed skill levels of the possessed skills on the basis of the person-in-charge table and the possessed skill table within the management information. Further, the person-in-charge determining unit 32 specifies required skills of an event to which the handler is to be allocated (hereinafter, referred to as the event) and required skill levels of the required skills from the event table. The person-in-charge determining unit 32 judges whether or not the candidates for the person in charge having the person-in-charge candidate IDs have all the required skills for the event as the possessed skill levels, and whether or not the possessed skill levels of the candidates for the person in charge are equal to or larger than the required skill levels in all the required skills on the basis of the specified possessed skills and the possessed skill levels, and the required skills and the required skill levels (step S301).

In a case where the candidates for the person in charge possess all the required skills, and the possessed skill levels of the candidates for the person in charge are equal to or larger than the required skill levels in all the required skills, the person-in-charge determining unit 32 judges that the candidates for the person in charge can cope with the event and can educate the required skills to other persons in charge, and classifies the candidates for the person in charge as “persons in charge who can handle an event and who can educate” which is a first class. The person-in-charge determining unit 32 then adds the person-in-charge candidate IDs to a list of persons in charge who can handle the event and who can educate (step S302).

In a case where the candidates for the person in charge possess all the required skills, and the possessed skill levels of the candidates for the person in charge are not equal to or larger than the required skill levels in all the required skills, the person-in-charge determining unit 32 judges whether or not the candidates for the person in charge of the person-in-charge candidate IDs possess all the required skills for the event (step S303). That is, the person-in-charge determining unit 32 judges whether or not the candidates for the person in charge possess all the required skills, and whether or not the possessed skill levels of the candidates for the person in charge are equal to or larger than the required skill levels in all the required skills.

In a case where the candidates for the person in charge possess all the required skills, the person-in-charge determining unit 32 judges that the candidates for the person in charge can cope with the event, but cannot educate other persons about the required skills, and classifies the candidates for the person in charge into “persons in charge who can handle an event” which is a second class. The person-in-charge determining unit 32 then adds the person-in-charge candidate IDs to the list of persons in charge who can handle an event (step S304).

In a case where the candidates for the person in charge do not possess all the required skills, the person-in-charge determining unit 32 judges whether or not the candidates for the person in charge having the person-in-charge candidate IDs should master the required skills as the educational skills, that is, whether or not the required skills are configured as the educational skills for the candidates for the person in charge (step S305).

In a case where the candidates for the person in charge configure the required skills for the event as the educational skills, the person-in-charge determining unit 32 judges that the candidates for person in charge should master (receive education) the required skills for coping with the event, and classifies the candidates for the person in charge into “persons in charge to be educated” which is a third class. The person-in-charge determining unit 32 adds the person-in-charge candidate IDs to a list of the persons in charge to be educated (step S306).

If the loop A is finished, in step S205, the person-in-charge determining unit 32 generates a list of persons in charge who can handle an event and who can educate, a list of persons in charge who can handle an event, and a list of persons in charge to be educated, as the list of candidates for the person in charge.

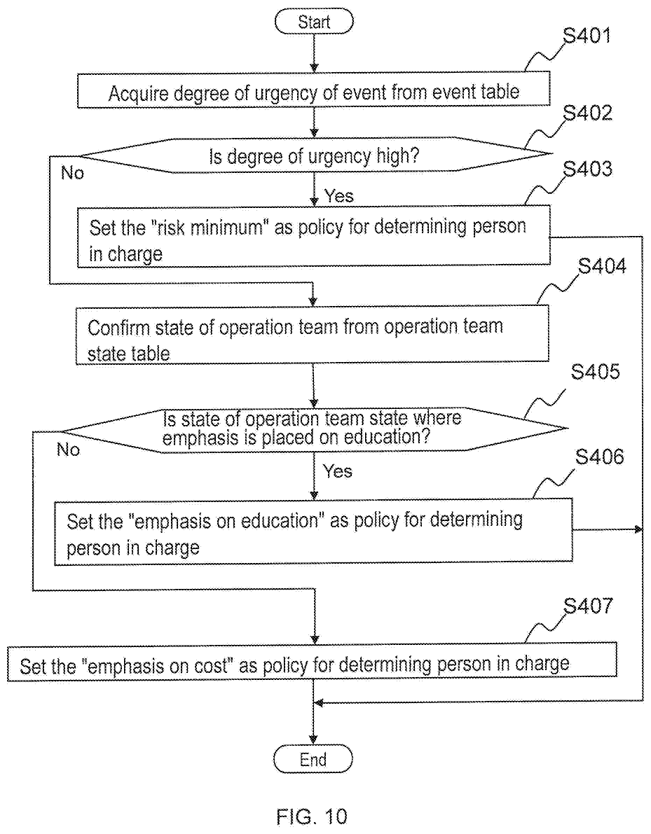

FIG. 10 is a flowchart for explaining the processing of examining policy for determining a person in charge in step S102 in FIG. 7 in more detail.

In the processing of examining policy for determining a person in charge, the person-in-charge determining unit 32 acquires a degree of urgency of the event from the event table (step S401).

The person-in-charge determining unit 32 judges whether or not the acquired degree of urgency is equal to or larger than a predetermined threshold (step S402). In the present embodiment, the degree of urgency is expressed with a binary of “1 (high)” and “0 (low)”, and the threshold is “1 (high)”. Note that the degree of urgency may be expressed with three or more values.

In a case where the degree of urgency is equal to or larger than the threshold, the person-in-charge determining unit 32 sets a “risk minimum” as policy for determining a person in charge (step S403).

In a case where the degree of urgency is smaller than the threshold, the person-in-charge determining unit 32 confirms a state of the operation team from the operation team state table of the management information (step S404).

The person-in-charge determining unit 32 judges whether or not the state of the operation team is a state where emphasis is placed on education (step S405).

In a case where the state of the operation team is a state where emphasis is placed on education, the person-in-charge determining unit 32 sets an “emphasis on education” as the policy for determining a person in charge (step S406).

In a case where the state of the operation team is not the state where emphasis is placed on education, the person-in-charge determining unit 32 sets an “emphasis on cost” as the policy for determining a person in charge (step S407).

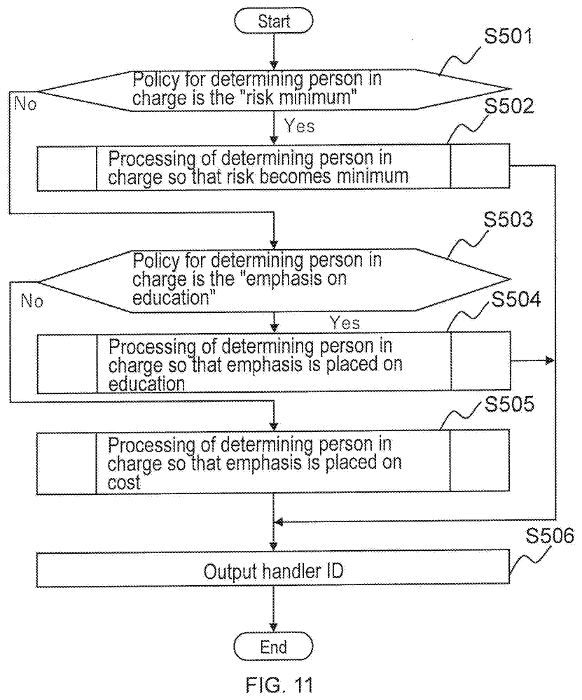

FIG. 11 is a flowchart for explaining the processing of determining a handler in step S103 in FIG. 7 in more detail.

In the processing of determining a handler, the person-in-charge determining unit 32 judges whether or not the policy for determining a person in charge is the “risk minimum” (step S501).

In a case where the policy for determining a person in charge is the “risk minimum”, the person-in-charge determining unit 32 executes processing of determining a person in charge so that a risk becomes a minimum, which determines a handler in accordance with the “risk minimum” (step S502).

In a case where the policy for determining a person in charge is not the “risk minimum”, the person-in-charge determining unit 32 judges whether or not the policy for determining a person in charge is the “emphasis on education” (step S503).

In a case where the policy for determining a person in charge is the “emphasis on education”, the person-in-charge determining unit 32 executes processing of determining a person in charge so that emphasis is placed on education, which determines a handler in accordance with the “emphasis on education” (step S504).

In a case where the policy for determining a person in charge is not the “emphasis on education”, the person-in-charge determining unit 32 executes processing of determining a person in charge so that emphasis is placed on cost, which determines a handler in accordance with the “emphasis on cost” (step S505).

After step S502, S504 or S505 is finished, the person-in-charge determining unit 32 makes a notification of the determined handler using a predetermined form (such as, for example, display). Further, the person-in-charge determining unit 32 transmits a request for registering the handler including the person-in-charge ID of the handler and the event ID of the event to the system management apparatus 20. The event managing unit 22 of the system management apparatus 20 receives the request for registering the handler, registers the person-in-charge ID and the event ID included in the request for registering the handler in the event table 200 in association with each other, and finishes the processing.

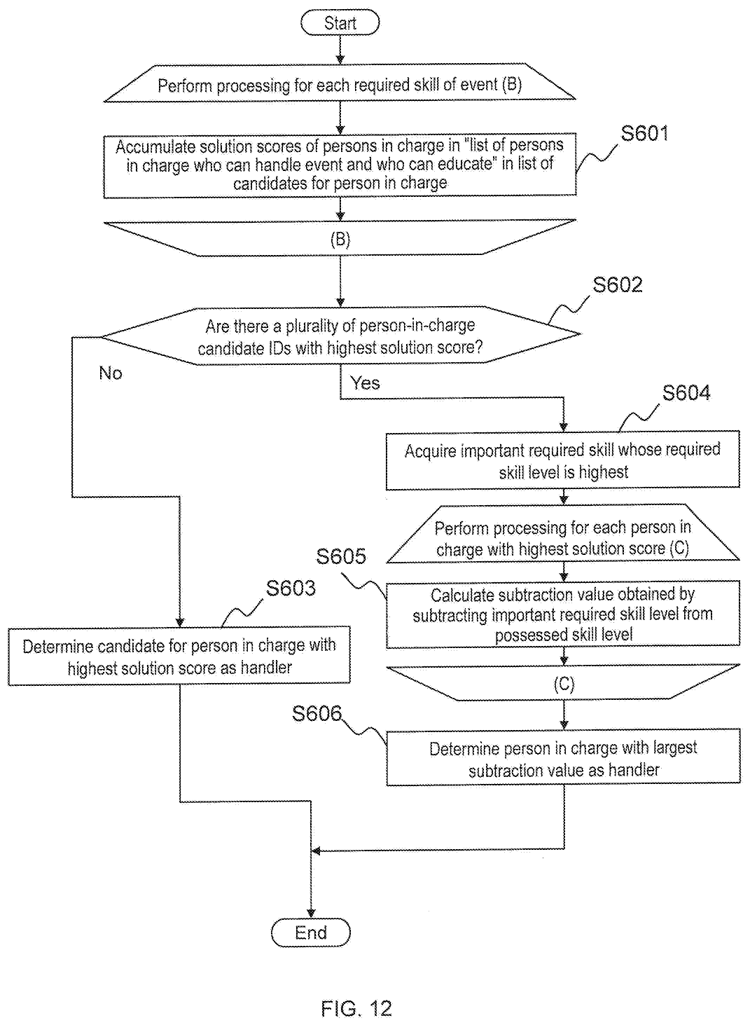

FIG. 12 is a flowchart for explaining the processing of determining a person in charge so that a risk becomes a minimum in step S502 in FIG. 11 in more detail.

In the processing of determining a person in charge so that a risk becomes a minimum, the person-in-charge determining unit 32 first repeats processing in step S601 for each required skill corresponding to the event ID of the event in the event table (loop B).

In the loop B, the person-in-charge determining unit 32 adds a score value corresponding to the required skill to a solution score for each of the person-in-charge candidate IDs included in the list of persons in charge who can handle an event and who can educate of the list of candidates for the person in charge (step S601). The solution score is a value indicating a degree of ability of solving the event, and the score value is a value obtained by subtracting the required skill level of the required skill from the possessed skill level of the candidate for the person in charge regarding the required skill. An initial value of the solution score is configured at 0, or the like, in advance.

After the loop B is finished, the person-in-charge determining unit 32 judges whether or not there are a plurality of person-in-charge candidate IDs with the highest solution score (step S602).

In a case where there is not a plurality of person-in-charge candidate IDs with the highest solution score, the person-in-charge determining unit 32 allocates a candidate for a person in charge having the person-in-charge candidate ID with the highest solution score as the handler, and determines the person-in-charge candidate ID as the handler ID (step S603).

In a case where there are a plurality of person-in-charge candidate IDs with the highest solution score, the person-in-charge determining unit 32 acquires an important required skill with the highest required skill level among required skills corresponding to the event ID from the event table (step S604).

The person-in-charge determining unit 32 then repeats processing in step S605 for each person-in-charge candidate ID with the highest solution score (loop C).

In the loop C, the person-in-charge determining unit 32 calculates a subtraction value obtained by subtracting a required skill level of the important required skill from the possessed skill level of the person-in-charge candidate ID with the highest solution score regarding the important required skill (step S605).

After the loop C is finished, the person-in-charge determining unit 32 allocates the candidate for a person in charge having the person-in-charge candidate ID with the highest subtraction value calculated in step S605 as the handler, determines the person-in-charge candidate ID as the handler ID (step S606) and finishes the processing.

Through the processing described above, in a case where the degree of urgency is equal to or larger than the threshold, it is possible to allocate a candidate for a person in charge who has the highest ability of solving the event as the handler among the candidates for the person in charge who possess the required skills as the possessed skills.

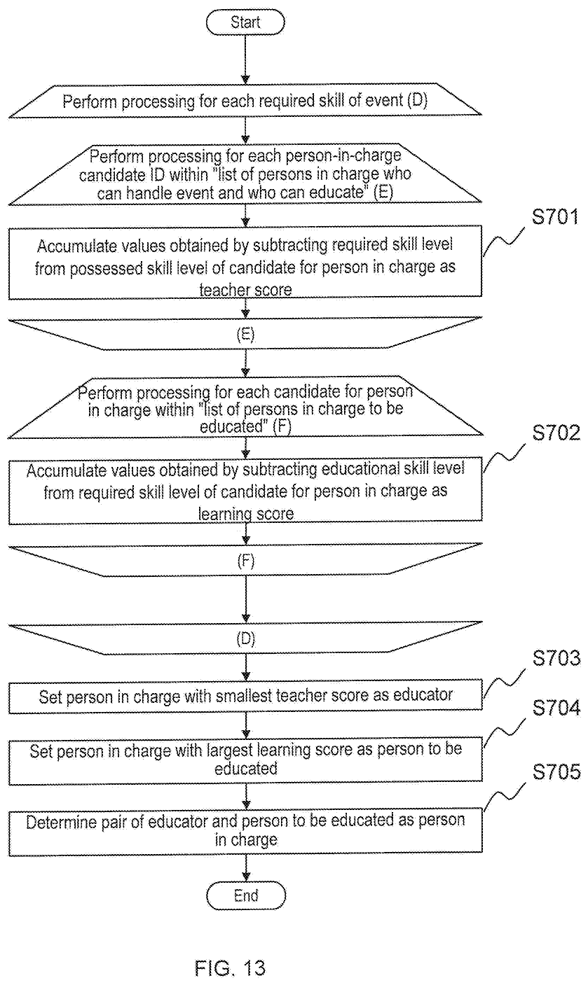

FIG. 13 is a flowchart for explaining the processing of determining a person in charge so that emphasis is placed on education in step S504 in FIG. 11 in more detail.

In the processing of determining a person in charge so that emphasis is placed on education, the person-in-charge determining unit 32 first repeats the processing in step S701 and S702 for each required skill corresponding to the event ID of the event in the event table (loop D).

In the loop D, the person-in-charge determining unit 32 first executes the processing in step S701 for each person-in-charge candidate ID included in the list of persons in charge who can handle the event and who can educate (loop E).

In the loop E, the person-in-charge determining unit 32 adds a score value corresponding to the required skill to a teacher score for the person-in-charge candidate ID (step S701). The teacher score is a value indicating a degree of ability of teaching the required skill of the event, and the score value is a value obtained by subtracting the required skill level of the required skill from the possessed skill level of the candidate for the person in charge regarding the required skill. An initial value of the teacher score is configured at 0, or the like, in advance.

After the loop E is finished, the person-in-charge determining unit 32 executes the processing in step S702 for each person-in-charge candidate ID included in the list of persons in charge to be educated (loop F).

In the loop F, the person-in-charge determining unit 32 adds a score value corresponding to the required skill to a learning score for the person-in-charge candidate ID (step S702). The learning score is a value indicating a degree to which the required skill of the event should be mastered, and the score value is a value obtained by subtracting the educational skill level of the candidate for the person in charge from the required skill level regarding the required skill.

After the loop F is finished, the processing returns to the beginning of the loop D. After the loop D is finished, the person-in-charge determining unit 32 determines a candidate for a person in charge having the person-in-charge candidate ID with the smallest teacher score as an educator who educates other persons in charge about the required skill, and selects the person-in-charge candidate ID as an educator ID (step S703). Note that, because the teacher score is an integration value of values obtained by subtracting the required skill levels from the possessed skill levels for each required skill, and the required skill level does not depend on the person in charge, the person-in-charge candidate ID with the smallest teacher score becomes the same as the person-in-charge candidate ID with the smallest possessed skill level.

The person-in-charge determining unit 32 then determines a candidate for a person in charge having the person-in-charge candidate ID with the largest learning score as a person to be educated who is to be educated by the educator about the required skill, and selects the person-in-charge ID as a person-to-be-educated ID (step S704).

The person-in-charge determining unit 32 allocates a pair of the educator and the person to be educated as persons in charge, determines a pair of the educator ID and the person-to-be-educated ID as handler IDs (step S705), and finishes the processing.

Note that a larger learning score indicates larger potential, more specifically, indicates that the person in charge is more likely to develop his/her skill by coping with the event with the educator. Further, as a smaller teacher score indicates that the person in charge possesses a (minimum required) skill level appropriate for educating, and a larger teacher score indicates that the person in charge possesses a skill level higher than necessary.

Through the above-described processing, in a case where the degree of urgency is smaller than the threshold, it is possible to allocate a person in charge whose possessed skill levels are equal to or larger than the required skill levels in all the required skills, and allocate a person in charge whose educational skill level is smaller than the required skill level as the person to be educated.

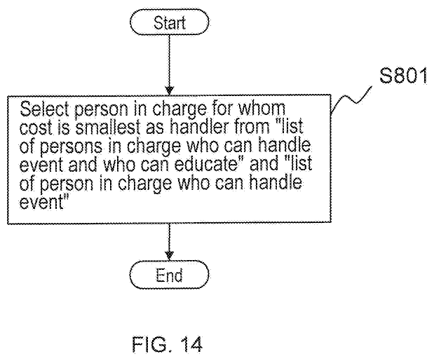

FIG. 14 is a flowchart for explaining the processing of determining a person in charge so that emphasis is placed on cost in step S505 in FIG. 11 in more detail.

In the processing of determining a person in charge so that emphasis is placed on cost, the person-in-charge determining unit 32 determines a person-in-charge candidate ID with the smallest cost as the handler ID among the person-in-charge candidate IDs included in the list of persons in charge who can handle the event and who can educate and the list of persons in charge who can handle the event (step S801) and finishes the processing.

Although, in the operation described above, in a case where the state of the operation team is not the state where emphasis is placed on education, the person-in-charge determining unit 32 allocates a person in charge with the smallest cost as the handler on the basis of the policy for determining a person in charge of the “emphasis on cost”, the handler may be determined on the basis of predetermined policy different from the policy of the “emphasis on cost”. For example, the person-in-charge determining unit 32 may determine the handler on the basis of the “risk minimum”.

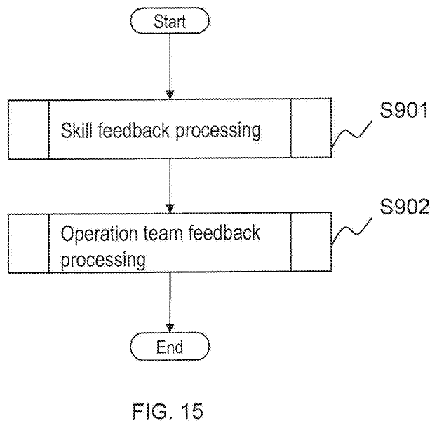

FIG. 15 is a flowchart for explaining operation of the information updating unit 33. Note that the operation illustrated in FIG. 15 is preferably performed after coping of the event is finished. For example, if termination information indicating that coping of the event is finished and the event ID of the event for which coping has been finished are input to the person-in-charge allocation apparatus 30 from a manager of the information system or the handler, the information updating unit 33 executes the operation illustrated in FIG. 15. Further, the operation illustrated in FIG. 15 may be regularly performed.

The information updating unit 33 first executes skill feedback processing of updating information regarding the possessed skill and the educational skill (step S901).

Thereafter, the information updating unit 33 executes operation team feedback processing of updating information regarding the state of the operation team (step S902).

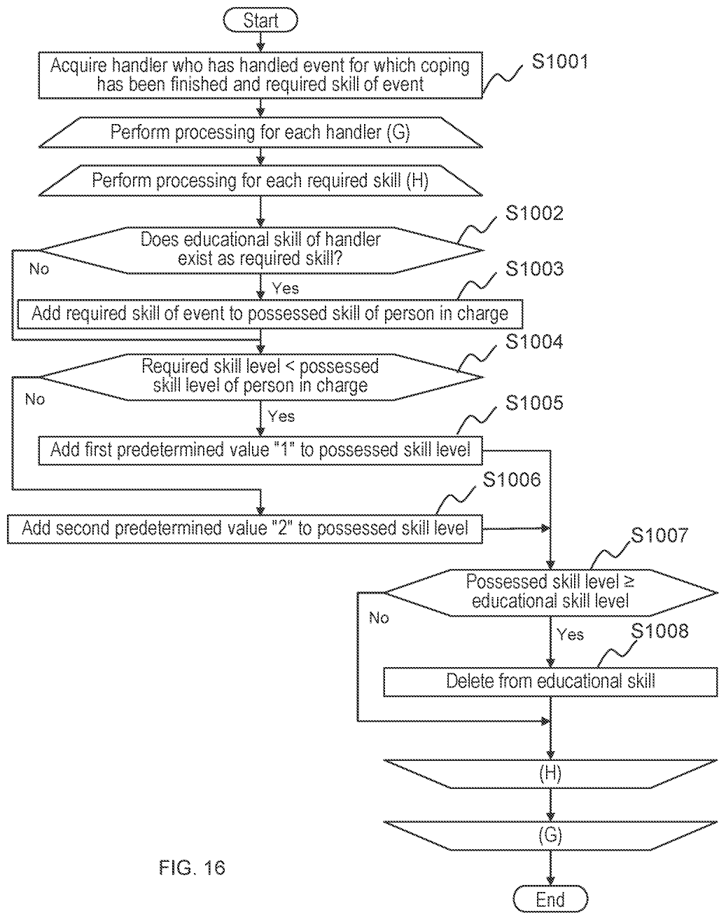

FIG. 16 is a flowchart for explaining the skill feedback processing in step S901 in FIG. 15 in more detail.

The information updating unit 33 acquires the handler ID and the required skill set corresponding to the event ID of an end event which is an event for which coping has been finished from the event table (step S1001).

The information updating unit 33 then repeats the loop H for each handler ID (loop G).

In the loop G, the information updating unit 33 repeats the processing from step S1002 to S1008 (loop H).

In the loop H, the information updating unit 33 judges whether or not an educational skill corresponding to the handler ID exists as the required skill corresponding to the event ID of the end event in the management information (step S1002).

In a case where the educational skill exists as the required skill, the information updating unit 33 adds the required skill to the possessed skill corresponding to the handler ID of the management information (the person-in-charge table and the possessed skill table). At this time, the information updating unit 33 configures a predetermined value (for example, the smallest value) as the possessed skill level of the possessed skill (step S1003).

In a case where the educational skill does not exist as the required skill, and in a case where step S1003 is finished, the information updating unit 33 judges whether or not the required skill level is smaller than the possessed skill level (step S1004).

In a case where the required skill level is smaller than the possessed skill level, the information updating unit 33 adds a first predetermined value (here, 1) to the predetermined skill level (step S1005).

In a case where the required skill level is equal to or larger than the possessed skill level, the information updating unit 33 adds a second predetermined value (here, 2) larger than the first predetermined value to the possessed skill level (step S1006).

In a case where step S1005 is finished, and, in a case where step S1006 is finished, the information updating unit 33 judges whether or not the possessed skill level is equal to or larger than the educational skill level (step S1007).

In a case where the possessed skill level is equal to or larger than the educational skill level, the information updating unit 33 deletes the educational skill corresponding to the handler ID from the person-in-charge table (step S1008). Note that, in a case where the possessed skill level is smaller than the educational skill level, the information updating unit 33 finishes the processing without deleting the educational skill corresponding to the handler ID from the person-in-charge table.

Although, in the operation described above, the information updating unit 33 adds the first predetermined value to the possessed skill level in a case where the required skill level is smaller than the possessed skill level, and adds the second predetermined value which is larger than the first predetermined value to the possessed skill level in a case where the required skill level is equal to or larger than the possessed skill level, it is also possible to add the same predetermined value in both cases. Further, more typically, the information updating unit 33 may delete the educational skill on the basis of the allocation result of the handler by the person-in-charge determining unit 32. For example, the information updating unit 33 may delete the educational skill corresponding to the handler ID from the person-in-charge table regardless of the educational skill level.

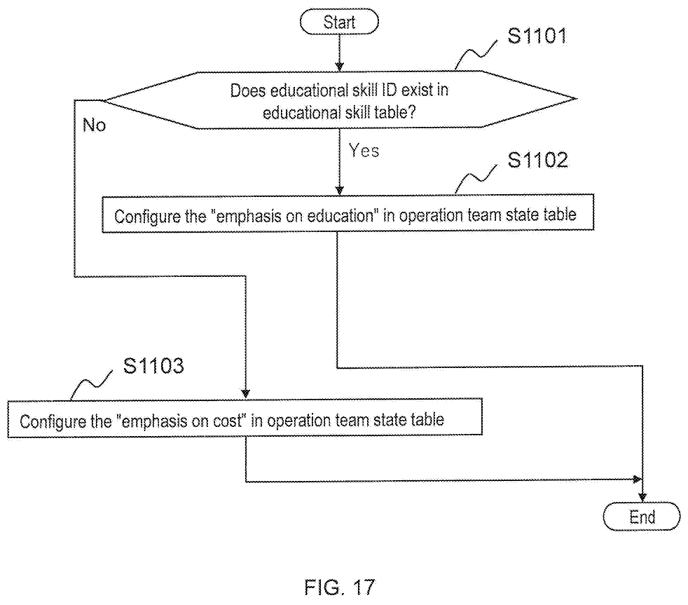

FIG. 17 is a flowchart for explaining the operation team feedback processing in step S902 in FIG. 15 in more detail.

In the operation team feedback processing, first, the information updating unit 33 judges whether or not the educational skill ID exists in the educational skill table of the management information (step S1101).

In a case where the educational skill ID exists, the information updating unit 33 configures the state where emphasis is placed on education as the state of the operation team indicated in the operation team state table (step S1102), and finishes the processing.

Meanwhile, in a case where the educational skill ID does not exist, the information updating unit 33 configures the state where emphasis is placed on cost as the state of the operation team indicated in the operation team state table (step S1103), and finishes the processing.

As described above, the present disclosure includes the following matters.

The person-in-charge allocation apparatus (30) according to one aspect of the present disclosure, which is a person-in-charge allocation apparatus which allocates a handler who is to cope with an event from a plurality of persons in charge, includes a storage unit (31) and a person-in-charge determining unit (32). The storage unit stores management information indicating a possessed skill possessed by the person in charge and an educational skill which is a skill to be mastered by the person in charge for each person in charge (for each person-in-charge ID). The person-in-charge determining unit sets a person in charge who possesses the required skill as the possessed skill as an educator and sets a person in charge who is to master the required skill as the educational skill as the person to be educated, based on event information (event table) indicating a required skill which is a skill for coping with the event and the management information, and then allocates the educator and the person to be educated as the handlers.

In this case, the educator who is a person in charge who possesses the required skill which is a skill for coping with the event as the possessed skill, and the person to be educated who is a person in charge who should master the required skill as the educational skill are allocated as the handlers who are to cope with the event. Therefore, because the educator who possesses the required skill and the person to be educated who should master the required skill can become a pair to cope with the event, it becomes possible to convey the required skill from the educator to the person to be educated while coping with the event. Therefore, because it becomes possible to develop the person in charge and share skills, it becomes possible to stably operate the information system.

Further, the event information further indicates a degree of urgency of the event. The person-in-charge determining unit allocates the educator and the person to be educated as the handlers in a case where the degree of urgency is smaller than a threshold, and allocates a person in charge who possesses the required skill as the possessed skill as the handler in a case where the degree of urgency is equal to or larger than the threshold.

In this case, in a case where the degree of urgency is smaller than the threshold, the educator and the person to be educated are allocated as the handlers. Therefore, because it is possible to educate the person in charge in the event with a low degree of urgency, it is possible to educate the person in charge while suppressing influence on operation of the information system.

Further, the management information further indicates a possessed skill level which is a level of the person in charge regarding the possessed skill and an educational skill level which is a level of the educational skill to be mastered by the person in charge for each person in charge. The event information further indicates a required skill level which is a level of the required skill, desired for coping of the event. The person-in-charge determining unit sets a person in charge whose possessed skill level is equal to or larger than the required skill level as the educator and sets a person in charge whose educational skill level is smaller than the required skill level as the person to be educated.

In this case, a person in charge whose possessed skill level is equal to or larger than the required skill level becomes the educator, and a person in charge whose educational skill level is smaller than the required skill level becomes the person to be educated. Therefore, because it becomes possible to appropriately allocate the educator and the person to be educated while taking into account a level of difficulty of the event and ability of coping with the event, it is possible to provide efficient education.

Further, the person-in-charge determining unit determines a person in charge whose possessed skill level is the smallest as the educator among persons in charge whose possessed skill levels are equal to or larger than the required skill level. Therefore, because it becomes possible to set a person in charge having a minimum required skill level as the educator, it becomes possible to provide efficient education.

Further, the person-in-charge determining unit determines a person in charge for which a value obtained by subtracting the educational skill level from the required skill level is the largest as the person to be educated among persons in charge whose educational skill levels are smaller than the required skill level. Therefore, because it becomes possible to set a person in charge who is likely to develop his/her skill as the person to be educated, it becomes possible to provide efficient education.

Further, the management information further indicates a state indicating whether or not emphasis is placed on education of the person in charge (the state of the operation team). The person-in-charge determining unit allocates the educator and the person to be educated as the handlers in a case where the state indicates that emphasis is placed on education of the person in charge (in a case of the state where emphasis is placed on education), and allocates the handler in accordance with predetermined policy (“of placing emphasis on cost”) in a case where the state indicates that emphasis is not placed on education of the person in charge (in a case of the state where emphasis is placed on cost).

In this case, in a case where emphasis is placed on education, the educator and the person to be educated are allocated. Therefore, it is possible to appropriately perform education in accordance with a situation of the operation team.

The management information further indicates expense (cost) when the person in charge is set as the handler for each person in charge. The person-in-charge determining unit allocates a person in charge for whom expense is the lowest as the handler in a case where the state is a state where emphasis is not placed on education of the person in charge. In this case, in a case where emphasis is not placed on education, it becomes possible to cope with the event at low cost.

Further, the person-in-charge allocation apparatus (30) further includes an information updating unit (33). The information updating unit adds a predetermined value to the possessed skill level of the person in charge allocated as the handler. Therefore, because it is possible to reflect ability improved by coping with the event in the possessed skill level, it is possible to appropriately manage the possessed skill level of the person in charge.

The information updating unit adds the first predetermined value as the predetermined value in a case where the required skill level is smaller than the possessed skill level of the person in charge allocated as the handler, and adds the second predetermined value which is larger than the first predetermined value, as the predetermined value in a case where the required skill level is equal to or larger than the possessed skill level of the person in charge allocated as the handler.

In this case, in a case where the possessed skill level of the handler is larger than the required skill level, the first predetermined value is added as the predetermined value, and, in a case where the possessed skill level of the handler is equal to or smaller than the required skill level, the second predetermined value which is larger than the first predetermined value is added as the predetermined value. Therefore, because it is possible to reflect ability improved by coping with the event in the possessed skill level more appropriately in accordance with the possessed skill level and the required skill level, it is possible to manage the possessed skill level of the person in charge more appropriately.

The information updating unit deletes the educational skill of the person to be educated from the management information if the possessed skill level of the person to be educated after the predetermined value is added becomes equal to or larger than the educational skill level of the person to be educated. Therefore, because it becomes possible to delete the educational skill from the management information in a case where the skill is sufficiently mastered, it becomes possible to appropriately perform education.

The information updating unit deletes the educational skill of the person in charge allocated as the person to be educated from the management information on the basis of the allocation result of the handler, and, if the educational skill disappears in the management information, changes the state to a state where education of the person in charge is not desired. Therefore, if the educational skill disappears in the management information, because the state is changed to a state where education of the person in charge is not desired, it becomes possible to appropriately perform education.

In a case where there are a plurality of required skills, the person-in-charge determining unit sets the person in charge who possesses all the plurality of required skills as the possessed skills, as the educator. Therefore, because it becomes possible to allocate an appropriate person in charge as the educator in accordance with the event, it becomes possible to appropriately perform education.

In a case where there are a plurality of required skills, the person-in-charge determining unit sets a person in charge who possesses all the plurality of required skills as the possessed skills and whose possessed skill levels are equal to or larger than the required skill levels in all the required skills, as the educator. Therefore, because it becomes possible to allocate an appropriate person in charge as the educator in accordance with the event, it becomes possible to appropriately perform education.

The embodiment of the present invention described above is an example for explaining the present invention, and does not limit the scope of the present invention only to the embodiment. A person skilled in the art can implement the present invention in other various aspects without deviating from the scope of the present invention.

What is claimed is:

1. A person-in-charge allocation apparatus which allocates a handler who is to cope with an event from a plurality of persons in charge, the person-in-charge allocation apparatus comprising:
a storage unit configured to store management information indicating a possessed skill which is a skill possessed by the person in charge and an educational skill which is a skill to be mastered by the person in charge for each of the persons in charge; and
a person-in-charge determining unit configured to set a person in charge who possesses the required skill as the possessed skill as an educator and to set a person in charge who is to master the required skill as the educational skill as the person to be educated, based on event information indicating a required skill which is a skill for coping with the event and the management information, and then to allocate the educator and the person to be educated as the handlers.

2. The person-in-charge allocation apparatus according to claim 1,
wherein the event information further indicates a degree of urgency of the event, and
the person-in-charge determining unit allocates the educator and the person to be educated as the handlers in a case where the degree of urgency is smaller than a threshold, and allocates a person in charge who possesses the required skill as the possessed skill as the handler in a case where the degree of urgency is equal to or larger than the threshold.

3. The person-in-charge allocation apparatus according to claim 1,
wherein the management information further indicates a possessed skill level which is a level of the person in charge regarding the possessed skill and an educational skill level which is a level of the educational skill to be mastered by the person in charge, for each of the persons in charge,
the event information further indicates a required skill level which is a level of the required skill, desired for coping of the event, and
the person-in-charge determining unit sets a person in charge whose possessed skill level is equal to or larger than the required skill level as the educator, and sets a person in charge whose educational skill level is smaller than the required skill level as the person to be educated.

4. The person-in-charge allocation apparatus according to claim 3,
wherein the person-in-charge determining unit determines a person in charge whose possessed skill level is the smallest as the educator among persons in charge whose possessed skill levels are equal to or larger than the required skill levels.

5. The person-in-charge allocation apparatus according to claim 3,
wherein the person-in-charge determining unit determines a person in charge for whom a value obtained by subtracting the educational skill level from the required skill level is the largest as the person to be educated among persons in charge whose educational skill levels are smaller than the required skill level.

6. The person-in-charge allocation apparatus according to claim 1,
wherein the management information further indicates a state which indicates whether or not emphasis is placed on education of the person in charge, and
the person-in-charge determining unit allocates the educator and the person to be educated as the handlers in a case where the state indicates that emphasis is placed on education of the person in charge, and allocates the handler in accordance with predetermined policy in a case where the state indicates that emphasis is not placed on education of the person in charge.

7. The person-in-charge allocation apparatus according to claim 6,
wherein the management information further indicates expense when the person in charge is set as the handler for each of the persons in charge, and
the person-in-charge determining unit allocates a person in charge for whom the expense is the lowest as the handler in a case where the state indicates that emphasis is not placed on education of the person in charge.

8. The person-in-charge allocation apparatus according to claim 3, further comprising:
an information updating unit configured to add a predetermined value to the possessed skill level of the person in charge allocated as the handler.

9. The person-in-charge allocation apparatus according to claim 8,
wherein the information updating unit adds a first predetermined value as the predetermined value in a case where the required skill level is smaller than the possessed skill level of the person in charge allocated as the handler, and adds a second predetermined value which is larger than the first predetermined value as the predetermined value in a case where the required skill level is equal to or larger than the possessed skill level of the person in charge allocated as the handler.

10. The person-in-charge allocation apparatus according to claim 8,
wherein the information updating unit deletes an educational skill of the person to be educated from the management information if a possessed skill level of the person to be educated after the predetermined value is added becomes equal to or larger than the educational skill level.

11. The person-in-charge allocation apparatus according to claim 7, further comprising:
an information updating unit configured to delete an educational skill of a person in charge allocated as the person to be educated from the management information on a basis of a result of allocation of the handler and the management information, and, if the educational skill disappears in the management information, change the state to a state where education of the person in charge is not desired.

12. The person-in-charge allocation apparatus according to claim 1,
wherein, in a case where there are a plurality of the required skills, the person-in-charge determining unit sets a person in charge who possesses all of the plurality of required skills as the possessed skills, as the educator.

13. The person-in-charge allocation apparatus according to claim 3,
wherein, in a case where there are a plurality of the required skills, the person-in-charge determining unit sets a person in charge who possesses all of the plurality of required skills as the possessed skills and whose possessed skill levels are equal to or larger than the required skill levels in all the required skills, as the educator.

14. A method for allocating a handler who is to cope with an event from a plurality of persons in charge, the method comprising:
storing management information indicating a possessed skill which is a skill possessed by the person in charge and an educational skill which is a skill to be mastered by the person in charge, for each of the persons in charge; and
setting a person in charge who possesses the required skill as the possessed skill as an educator and setting a person in charge who is to master the required skill as the educational skill as the person to be educated based on event information indicating a required skill which is a skill for coping with the event and the management information, and then allocating the educator and the person to be educated as the handlers.
